(19) United States
(12) Patent Application Publication
(10) Pub. No.: US 2006/0232571 A1
(43) Pub. Date: Oct. 19, 2006

(54) Stylus retaining mechanism

(75) Inventor: Che-Hung Huang, Taoyuan (TW)

Correspondence Address: BIRCH STEWART KOLASCH & BIRCH, PO BOX 747, FALLS CHURCH, VA, 22040-0747, US

(73) Assignee: HIGH TECH COMPUTER, CORP.

(21) Appl. No.: 11/205,135

(22) Filed: Aug. 17, 2005

(30) Foreign Application Priority Data
Apr. 15, 2005 (TW) 94111992

(51) Int. Cl. G09G 5/00

(52) U.S. Cl. 345/179

(57) ABSTRACT

A retaining mechanism for a stylus. A hollow receiving passage is surrounded by a passage wall. A holding member is connected to the passage wall and includes an abutting portion. The abutting portion protrudes from the passage wall and is disposed in the hollow receiving passage. A wear-resistant portion is disposed on the abutting portion and in the hollow receiving passage. The wear-resistant portion is parallel to the passage wall. The maximum vertical distance between the wear-resistant portion and the passage wall is less than a caliber of the stylus. The stylus is tightly abutted between the wear-resistant portion and the passage wall when received in the hollow receiving passage.

### BACKGROUND

The invention relates to a retaining mechanism, and in particular to a retaining mechanism for a stylus.

A conventional PDA is often equipped with a stylus, so that input and access of data can be performed on a touch panel thereof. When not used, the stylus is received in a retaining mechanism provided in the PDA.

Referring to FIG. 1, a conventional retaining mechanism 1 comprises a hollow receiving passage 11 and a holding member 12. The holding member 12 is connected to a passage wall 11a of the hollow receiving passage 11 and comprises an abutting portion 12a protruding from the passage wall 11a and disposed in the hollow receiving passage 11. Specifically, the abutting portion 12a is parallel to the passage wall 11a, with the maximum allowable vertical distance therebetween slightly less than the caliber (or diameter) of a stylus 2. Accordingly, as shown in FIG. 1, when inserted into the retaining mechanism 1, the stylus 2 is tightly abutted between the abutting portion 12a and the passage wall 11a. The stylus 2 is thus received in the PDA (or retaining mechanism 1).

Nevertheless, due to consideration of industrial design, the surface of the stylus 2 is often glossy or coarse while the abutting portion 12a of the holding member 12 is rubber or sponge. When the stylus 2 has a coarse surface, repeated insertion and withdrawal of the stylus 2 causes wear of the abutting portion 12a. Namely, the coarser the surface of the stylus 2, the more wear on the abutting portion 12a. Accordingly, when the wear on the abutting portion 12a reaches a critical level, the stylus 2 can no longer be abutted between the abutting portion 12a and the passage wall 11a and thereby received in the PDA (or retaining mechanism 1).

### SUMMARY

Accordingly, an exemplary embodiment of the invention provides a retaining mechanism for a stylus. The retaining mechanism comprises a hollow receiving passage, a holding member, and a wear-resistant portion. The hollow receiving passage is surrounded by a passage wall. The holding member is connected to the passage wall and comprises an abutting portion. The abutting portion protrudes from the passage wall and is disposed in the hollow receiving passage. The wear-resistant portion is disposed on the abutting portion and in the hollow receiving passage. The wear-resistant portion is parallel to the passage wall. The maximum vertical distance between the wear-resistant portion and the passage wall is less than a caliber of the stylus. The stylus is tightly abutted between the wear-resistant portion and the passage wall when received in the hollow receiving passage.

The wear-resistant portion comprises Teflon or plastic.

### DESCRIPTION OF THE DRAWINGS

The invention can be more fully understood by reading the subsequent detailed description and examples with references made to the accompanying drawings, wherein:

FIG. 1 is a partial cross section of a conventional retaining mechanism for a stylus;

FIG. 2 is a partial cross section of the retaining mechanism for a stylus of a first embodiment of the invention; and

FIG. 3 is a partial cross section of the retaining mechanism for a stylus of a second embodiment of the invention.

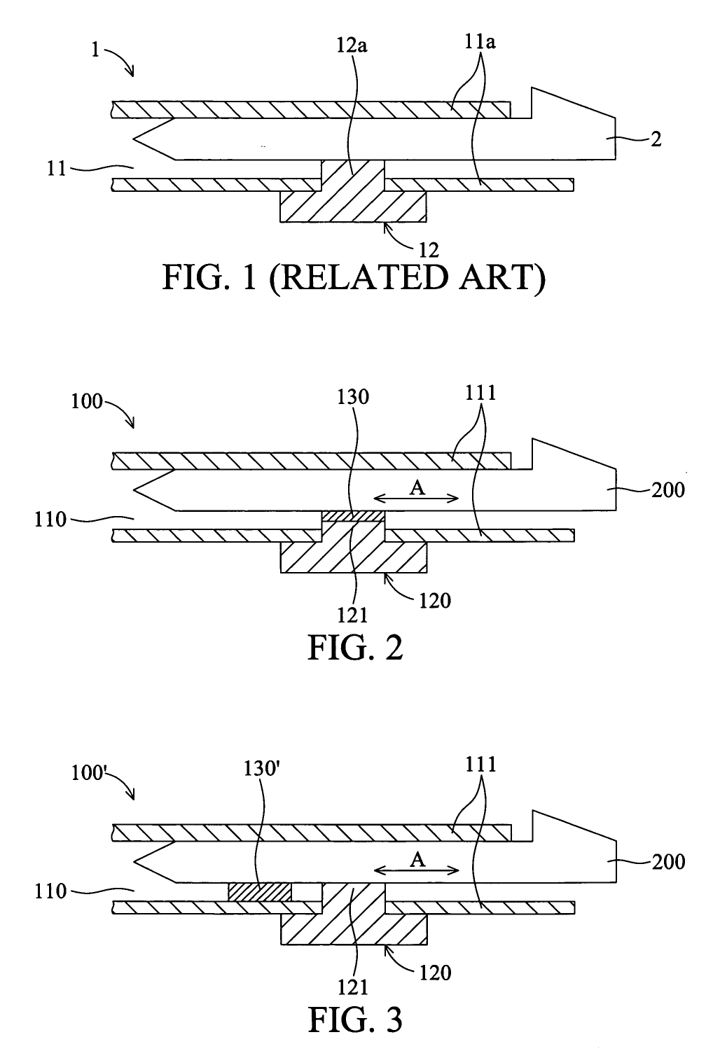

### DETAILED DESCRIPTION

### First Embodiment

Referring to FIG. 2, the retaining mechanism 100 comprises a hollow receiving passage 110, a holding member 120, and a wear-resistant portion 130.

The hollow receiving passage 110 is surrounded by a passage wall 111. The holding member 120 is connected to the passage wall 111 and comprises an abutting portion 121. As shown in FIG. 2, the abutting portion 121 protrudes from the passage wall 111 and is disposed in the hollow receiving passage 110.

The wear-resistant portion 130 is disposed on the abutting portion 121 and in the hollow receiving passage 110. Specifically, the wear-resistant portion 130 is parallel to the passage wall 111, with the maximum vertical distance therebetween slightly less than a caliber (or diameter) of the stylus 200. Accordingly, the stylus 200 is tightly abutted between the wear-resistant portion 130 and the passage wall 111 when received in the hollow receiving passage 110.

Moreover, the wear-resistant portion 130 may comprise stiff material, such as Teflon or plastic, thus providing excellent wear-resistance.

Accordingly, when the stylus 200 has a coarse surface and is repeatedly inserted into and withdrawn from the hollow receiving passage 110 of the retaining mechanism 100 in a direction indicated by arrow A, the wear-resistant portion 130 thereof is not easily subject to wear. The lifespan of the retaining mechanism 100 is thus prolonged.

### Second Embodiment

Elements corresponding to those in the first embodiment share the same reference numerals.

Referring to FIG. 3, the retaining mechanism 100′ comprises a hollow receiving passage 110, a holding member 120, and a wear-resistant portion 130′.

The hollow receiving passage 110 is surrounded by a passage wall 111. The holding member 120 is connected to the passage wall 111 and comprises an abutting portion 121. As shown in FIG. 3, the abutting portion 121 protrudes from the passage wall 111 and is disposed in the hollow receiving passage 110. Specifically, the abutting portion 121 is parallel to the passage wall 111, with the maximum vertical distance therebetween equaling a caliber (or diameter) of the stylus 200.

The wear-resistant portion 130′ is connected to the passage wall 111 and disposed in the hollow receiving passage 110. As shown in FIG. 3, the wear-resistant portion 130′ is also parallel to the passage wall 111 and separated from the abutting portion 121 by a predetermined distance. Specifically, the maximum vertical distance between the wear-resistant portion 130′ and the passage wall 111 is slightly less than the caliber (or diameter) of the stylus 200. Accordingly, the stylus 200 is tightly abutted between the wear-resistant portion 130′ and the passage wall 111 and supported between the abutting portion 121 and the passage wall 111 when received in the hollow receiving passage 110.

Similarly, the wear-resistant portion 130′ may comprise stiff material, such as Teflon or plastic, thus providing excellent wear-resistance.

Accordingly, when the stylus 200 has a coarse surface and is repeatedly inserted into and withdrawn from the hollow receiving passage 110 of the retaining mechanism 100′ in a direction indicated by arrow A, the wear-resistant portion 130′ thereof is not easily subject to wear. The lifespan of the retaining mechanism 100′ is thus prolonged.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A retaining mechanism for a stylus, comprising:
a hollow receiving passage surrounded by a passage wall;
a holding member connected to the passage wall and comprising an abutting portion, wherein the abutting portion protrudes from the passage wall and is disposed in the hollow receiving passage; and
a wear-resistant portion disposed on the abutting portion and in the hollow receiving passage, wherein the wear-resistant portion is parallel to the passage wall, with the maximum vertical distance therebetween less than a caliber of the stylus, and the stylus is tightly abutted between the wear-resistant portion and the passage wall when received in the hollow receiving passage.

2. The retaining mechanism as claimed in claim 1, wherein the wear-resistant portion comprises Teflon.

3. The retaining mechanism as claimed in claim 1, wherein the wear-resistant portion comprises plastic.

4. A retaining mechanism for a stylus, comprising:
a hollow receiving passage surrounded by a passage wall;
a holding member connected to the passage wall and comprising an abutting portion, wherein the abutting portion protrudes from the passage wall and is disposed in the hollow receiving passage; and
a wear-resistant portion connected to the passage wall and disposed in the hollow receiving passage, wherein the wear-resistant portion is parallel to the passage wall and separated from the abutting portion by a predetermined distance, with the maximum vertical distance therebetween less than a caliber of the stylus, and the stylus is tightly abutted between the wear-resistant portion and the passage wall and is supported by the abutting portion when received in the hollow receiving passage.

5. The retaining mechanism as claimed in claim 4, wherein the abutting portion is parallel to the passage wall, the maximum vertical distance between the abutting portion and the passage wall equals the caliber of the stylus, and the stylus is tightly abutted between the wear-resistant portion and the passage wall and is supported between the abutting portion and the passage wall.

6. The retaining mechanism as claimed in claim 4, wherein the wear-resistant portion comprises Teflon.

7. The retaining mechanism as claimed in claim 4, wherein the wear-resistant portion comprises plastic.
